(19) United States
(12) Patent Application Publication
(10) Pub. No.: US 2026/0055718 A1
(43) Pub. Date: Feb. 26, 2026

(54) REDUCTANT DELIVERY SYSTEM, EXHAUST TREATMENT SYSTEM AND VEHICLE COMPRISING THE EXHAUST TREATMENT SYSTEM

(71) Applicant: Scania CV AB, Södertälje (SE)

(72) Inventors: Arun Prasath Karuppasamy, Nykvarn (SE); Disa Öqvist, Stockholm (SE)

(73) Assignee: Scania CV AB, Södertälje (SE)

(21) Appl. No.: 19/306,236

(22) Filed: Aug. 21, 2025

(30) Foreign Application Priority Data
Aug. 26, 2024 (SE) 2450868-1

(51) Int. Cl. F01N 3/20; B01D 53/94; B01F 25/313; B01F 25/314; F01N 3/021; F01N 3/28; F01N 13/00

(52) U.S. Cl. CPC F01N 3/2066; B01D 53/9431; B01F 25/313; B01F 25/31432; F01N 3/021; F01N 3/2892; F01N 13/009; B01D 2251/2062; B01D 2257/404; F01N 2610/02; F01N 2610/1453

(57) ABSTRACT

A reductant delivery system configured to supply a reductant into an exhaust stream in an exhaust treatment system is presented. The reductant delivery system comprises: an evaporator configured to mix the reductant with the exhaust stream flowing through the evaporator; a reductant doser configured to provide the reductant in fluid form to a tube arrangement; and the tube arrangement configured between the reductant doser and at least one evaporating surface of the evaporator to receive the reductant in fluid form from the reductant doser and to deliver the reductant in fluid form at the at least one evaporating surface, such that the reductant is distributed as a liquid wall film on the at least one evaporating surface.

### CROSS-REFERENCE TO RELATED APPLICATION(S)

This application claims the benefit of priority to Swedish Patent Application No. 2450868-1 filed Aug. 26, 2024; the contents of which are also incorporated herein by reference.

### TECHNICAL FIELD

The present invention relates to a reductant delivery system, an exhaust treatment system, and a vehicle comprising the exhaust treatment system.

### BACKGROUND

The following background description constitutes a description of the background to the present invention, and thus need not necessarily constitute prior art.

In connection with increased government interests concerning pollution and air quality, primarily in urban areas, emission standards and regulations regarding emissions from combustion engines have been drafted in many jurisdictions.

Such emission standards often consist of requirements defining acceptable limits of exhaust emissions from combustion engines in for example vehicles. For example, emission levels of nitrogen oxides NOₓ, hydrocarbons CₓH_{y}, carbon monoxide CO and particles PM are often regulated by such standards for most types of vehicles. Vehicles equipped with combustion engines typically give rise to such emissions in varying degrees. In this document, the invention will be described mainly for its application in vehicles, i.e. for internal combustion engines. However, the invention may be used in substantially any application where combustion engines are used, for example in vessels such as ships or aeroplanes/helicopters, wherein regulations and standards for such applications limit emissions from the combustion engines.

In an effort to comply with these emission standards, the exhausts caused by the combustion of the combustion engine are treated/purified.

A common way of treating exhausts from a combustion engine comprises a so-called catalytic purification process, which is why vehicles equipped with a combustion engine usually comprise at least one catalyst. There are different types of catalysts, where the different respective types may be suitable depending on for example the combustion concept, combustion strategies and/or fuel types which are used in the vehicles, and/or the types of compounds in the exhaust stream to be purified. In relation to at least nitrous gases (nitrogen monoxide, nitrogen dioxide), referred to below as nitrogen oxides NOₓ, vehicles often comprise a catalyst, wherein a reductant, also commonly denoted additive, is supplied to the exhaust stream resulting from the combustion in the combustion engine, in order to reduce nitrogen oxides NOₓ, primarily to nitrogen gas and aqueous vapour. This is described in more detail below.

SCR (Selective Catalytic Reduction) catalysts are a commonly used type of catalysts for this type of reduction, primarily for heavy goods vehicles. SCR catalysts usually use ammonia NH₃, or a composition from which ammonia may be generated/formed, as a reductant/additive used for reducing the amount of nitrogen oxides NOₓ in the exhausts. The reductant/additive, for example urea, is injected into the exhaust stream resulting from the combustion engine upstream of the catalyst. The reductant added to the catalyst is adsorbed/stored in the catalyst, in the form of ammonia NH₃, so that a redox-reaction may occur between nitrogen oxides NOₓ in the exhausts and ammonia NH₃ available via the reductant.

### SUMMARY

When the reductant is injected into the exhaust stream, i.e. when the reductant is supplied/injected/dosed into the exhaust treatment system, small particles may be created from the reductant at the injection/dosing, i.e. may be created by the supply of the reductant into the exhaust stream. These small reductant particles are individual solid reductant particles, i.e. are separate/non-continuous small-sized solid particles of the reductant. These small reductant particles are thus different from the continuous/non-separated/non-individual particles of a reductant fluid. The individual solid reductant particles are very small in size, and may for example have a diameter less than 23 nm, often in the range of 10 nm to 23 nm. These individual solid reductant particles are therefore sometimes called sub-23 nm reductant particles. The individual solid reductant particles may comprise urea and/or by-products based on urea.

Due to their small size, the solid reductant based particles may flow with the exhaust stream through the entire exhaust treatment system and be emitted at the tailpipe. Thus, at least a portion of these individual solid reductant particles may, e.g. because of their small size, pass through each of the components of the exhaust treatment system, also through the SCR catalysts, and may be emitted into the environment as emissions. Measurements have shown that particles in the sub-23 nm range being measured in the tailpipe, i.e. being measured downstream of the exhaust treatment system, are often dominated by the small-sized solid reductant particles being formed/created at reductant dosing events in the exhaust treatment system.

The individual solid reductant particles may also comprise combustion-based particles, i.e. particles created at the combustion in the combustion engine. Thus, the individual solid reductant particles may then, due to possible interaction and/or mixing with particles from the combustion, comprise a mixture of reductant based particles and soot and/or ash. These small-sized reductant particles may thus, if being emitted, have health effects.

Also, the small-sized reductant particles may be included in future exhaust regulation. For example, according to some Euro 7 exhaust regulation proposals, particles having a diameter size from 10 nm are most likely to be included in the upcoming regulation. Thus, the more stringent particle emission limits in the Euro7 proposals means that, in addition to the limitation of combustion generated particles, also the small-sized solid reductant particles created by the dosing events are limited.

One objective of the present invention is therefore to at least partly prevent these small-sized solid reductant-based particles from being created.

According to an aspect, the objective is achieved through the above mentioned reductant delivery system configured to supply a reductant into an exhaust stream in an exhaust treatment system. The exhaust stream is a result of a combustion in a combustion engine and the exhaust treatment system is configured for treatment of the exhaust stream by utilization of the reductant. The reductant delivery system comprises:
an evaporator configured to mix the reductant with the exhaust stream flowing through the evaporator;
a reductant doser configured essentially in a center of a cross section of the evaporator to provide the reductant in fluid form to a tube arrangement, the cross section being perpendicular to a flow direction of the exhaust stream; and
the tube arrangement configured between the reductant doser and at least one evaporating surface of the evaporator to receive the reductant in fluid form from the reductant doser and to deliver the reductant in fluid form at the at least one evaporating surface, such that the reductant is distributed as a liquid wall film on the at least one evaporating surface.

Hereby, the small individual solid reductant particles, possibly having a diameter in the interval of 10 to 23 nm, are at least partly prevented from being created, and are thus prevented from being included in the exhaust stream.

By preventing the individual solid reductant particles from being created, by utilization of the herein presented reductant delivery system, the number of such particles being emitted from the tailpipe is considerably reduced, as compared to conventional solutions.

Thus, instead of adding additional components, such as for example different kinds of filters, in the exhaust treatment system in order to try to catch and/or dissolve such small individual solid reductant particles being carried by the exhaust stream before the particles are emitted from the tailpipe, the herein presented reductant delivery system at least partially prevents the small individual solid reductant particles from being created at all. In other words, the herein presented reductant delivery system focusses on taking action against, i.e. counteracting, the source/cause of these small individual solid reductant particles instead of trying to handle the already created particles, which has been the focus of known solutions. Hereby, problems which would otherwise be caused by such additional components for removing the particles, such as e.g. problems related to back pressure, increased fuel consumption and/or additional manufacturing costs, may be avoided when the herein presented reductant delivery system is used.

An exhaust treatment system comprising a reductant delivery system as herein described has the potential to meet the emission requirements in current and/or future emission standards, especially since the amount of small individual solid reductant particles being emitted from the tailpipe is considerably reduced.

According to an embodiment, the tube arrangement is configured in form of a wheel comprising:
a hub configured to receive the reductant in fluid form from the reductant doser;
two or more spoke tubes configured from the hub to a rim tube to provide the reductant in fluid form from the hub to the rim tube; and
the rim tube comprising two or more circumferential openings directed towards the at least one evaporating surface, the two or more circumferential openings being configured to provide the reductant in fluid form at the at least one evaporating surface.

The wheel-formed tube arrangement, comprising a hub, a number of spoke tubes and a rim tube, is mechanically robust. The two or more circumferential openings directed towards the at least one evaporating surface facilitate an improved and essentially even distribution of the reductant/additive as a liquid wall film on the at least one evaporating surface. Hereby, the vaporization of the reductant from the evaporation surface is also improved, and the decomposition of urea in the reductant into ammonia becomes efficient.

According to an embodiment, at least one of the two or more circumferential openings is shaped as a circular hole.

Hereby, a low-cost manufacturing of the tube arrangement is possible.

According to an embodiment,
at least one of the two or more circumferential openings is shaped as a guide slot; and
the guide slot is configured to provide the reductant in fluid form onto the at least one evaporating surface as a swirl.

The swirl causes an increased distribution of the reductant on the at least one evaporating surface. Thus, a well-spread liquid wall film is provided on the at least one evaporating surface.

According to an embodiment, the tube arrangement comprises:
a hub configured to receive the reductant in fluid form from the reductant doser; and
two or more spoke tubes configured radially from the hub towards the at least one evaporating surface, where each spoke tube comprises at least one delivery port configured adjacent to the at least one evaporating surface, respectively, the at least one delivery port being configured to deliver the reductant in fluid form at the at least one evaporating surface, respectively.

The tube arrangement, comprising a hub, a number of spoke tubes and one or more delivery ports adjacent to the at least one evaporating surface, facilitates the distribution of the reductant/additive as a liquid wall film on the at least one evaporating surface. Hereby, an efficient decomposition of urea in the reductant into ammonia, mixing of the reductant with the exhaust gas and/or vaporisation of the reductant is provided.

According to an embodiment, the two or more spoke tubes are configured in one axial plane perpendicular to the flow direction of the exhaust stream.

To arrange all spoke tubes in one and the same axial plane results in an axially compact tube arrangement, since the hub can be made short in the axial direction. Also, to arrange all spoke tubes in one and the same axial plane reduces production costs for the tube arrangement.

According to an embodiment,
the evaporator comprises two or more concentric evaporation pipes through which the exhaust stream flows, the two or more concentric evaporation pipes forming two or more evaporation surfaces, respectively; and
each spoke tube comprises two or more delivery ports, of which at least one delivery port is configured at each of the two or more evaporation surfaces.

By increasing the number of evaporation pipes to two or more, the total evaporation surface of the evaporator is considerably increased. Hereby, the efficiency of the mixing of the reductant with the emissions, e.g. with the exhaust gas, and/or of the vaporisation of the reductant is improved.

According to an embodiment, at least one of the two or more delivery ports is formed as a bend adjacent to an evaporation surface.

Hereby, an efficient distribution of the reductant on the at least one evaporating surface is provided, resulting in a well-spread liquid wall film on the at least one evaporating surface.

According to an embodiment, the two or more spoke tubes are arranged in a spiral configuration on the hub, such that each spoke tube is arranged in a separate axial plane perpendicular to the flow direction of the exhaust stream.

Hereby, the reductant is delivered in fluid form onto a large area of the at the at least one evaporating surface, i.e. on an area of the at the at least one evaporating surface being extended in the axial/flow direction.

According to an embodiment, the delivery of the reductant in fluid form at the at least one evaporating surface is configured to avoid transforming the reductant from the fluid form into a spray form when supplying the reductant into the exhaust stream.

By keeping the reductant in fluid form, the small individual solid reductant particles, possibly having a diameter in the interval of 10 to 23 nm, are prevented from being created. The amount of these small individual solid reductant particles being emitted from the tailpipe is hereby considerably reduced.

According to an embodiment, the delivery of the reductant in fluid form at the at least one evaporating surface is configured to prevent individual solid particles having a diameter less than 23 nm from being created by the supply of the reductant into the exhaust stream.

The amount of such small individual solid reductant particles being emitted from the tailpipe is hereby considerably reduced.

According to an embodiment, the individual solid particles comprise one or more in the group of:
urea; and
by-products based on urea.

By preventing these individual solid particles from being created, the dosing of urea upstream of the one or more SCR catalysts may be performed to optimize the reduction of nitrogen oxides NOₓ of the exhausts in the one or more SCR catalysts, essentially without considering possible emission of such individual solid particles.

According to an embodiment, the reductant comprises one or more in the group of:
ammonia; and
a substance from which ammonia may be extracted and/or released.

Reductants comprising ammonia provides for an efficient reduction of nitrogen oxides NOₓ in the exhausts by usage of the one or more SCR catalysts.

According to an embodiment, the tube arrangement is configured to deliver the reductant at a distance D in an interval of 0-10 mm from the at least one evaporating surface.

By delivering the reductant at a distance D in an interval of 0-10 mm from the at least one evaporating surface, i.e. directly onto or immediately adjacent the at least one evaporating surface, the reductant is kept in fluid form until it is distributed onto the at least one evaporating surface. This reduces the risk for creation of the individual solid reductant particles.

According to an aspect, the objective is achieved through the above mentioned exhaust treatment system arranged for treatment of an exhaust stream resulting from a combustion in a combustion engine. The exhaust treatment system comprises:
a particulate filter arranged to catch soot and ash created by the combustion;
the herein described reductant delivery system arranged downstream of the particulate filter, the reductant delivery system being configured to mix the reductant with the exhaust stream; and
a selective catalytic reduction catalyst arranged downstream of the reductant delivery system for reduction of nitrogen oxides NOₓ in the exhaust stream by utilization of the supplied reductant.

The exhaust treatment system has corresponding advantages as mentioned for the reductant delivery system.

According to an aspect, the objective is achieved through the above mentioned exhaust treatment system arranged for treatment of an exhaust stream resulting from a combustion in a combustion engine. The exhaust treatment system comprises:
an upstream dosing device arranged to supply a reductant into the exhaust stream;
an upstream selective catalytic reduction catalyst arranged downstream of the upstream dosing device for reduction of nitrogen oxides NOₓ in the exhaust stream by utilizing the supplied reductant;
a particulate filter arranged downstream of the upstream selective catalytic reduction catalyst to catch soot and ash created by the combustion;
the herein described reductant delivery system arranged downstream of the particulate filter, the reductant delivery system being configured to mix the reductant with the exhaust stream; and
a downstream selective catalytic reduction catalyst arranged downstream of the reductant delivery system to reduce nitrogen oxides NOₓ in the exhaust stream by utilizing the supplied reductant.

The exhaust treatment system has corresponding advantages as mentioned for the reductant delivery system.

According to an aspect, the objective is achieved through the above mentioned vehicle comprising an exhaust treatment system comprising the herein described reductant delivery system.

The vehicle has corresponding advantages as mentioned for the reductant delivery system.

### BRIEF LIST OF FIGURES

The invention will be illustrated in more detail below, along with the enclosed drawings, where similar references are used for similar parts, and where:

FIG. 1 shows an example vehicle which may comprise a reductant delivery system and/or an exhaust treatment system according to various aspects and/or embodiments of the present invention,

FIG. 2 shows an example of an exhaust treatment system in which aspects and/or embodiments of the present invention may be implemented,

FIG. 3 shows an example of an exhaust treatment system in which aspects and/or embodiments of the present invention may be implemented,

FIGS. 4a-c show various views of an evaporator and/or tube arrangements according to some aspects and/or embodiments of the present invention,

FIGS. 5a-b show various views of a tube arrangement according to some aspects and/or embodiments of the present invention,

FIGS. 6a-c show various views of an evaporator and/or tube arrangements according to some aspects and/or embodiments of the present invention,

FIGS. 7a-d show various views of an evaporator and/or tube arrangements according to some embodiments aspects and/or of the present invention, and

FIGS. 8a-e show various views of an evaporator and/or tube arrangements according to some aspects and/or embodiments of the present invention.

### DETAILED DESCRIPTION

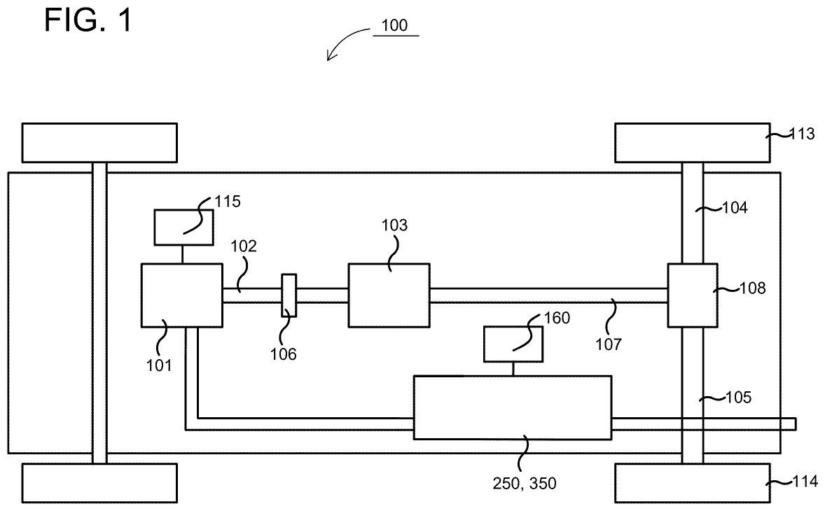

FIG. 1 schematically shows an example vehicle 100 comprising an exhaust treatment system 250, 350, which may be an exhaust treatment system 250, 350 according to an aspect or embodiment of the present invention. The powertrain of the vehicle comprises a combustion engine 101, which in a customary manner, via an output shaft 102 of the combustion engine 101 is connected to a gearbox 103 via a clutch 106. An output shaft 107 from the gearbox 103 may drive the wheels 113, 114 e.g. via a final drive 108, such as e.g. a customary differential, and the drive shafts 104, 105 connected to the said final drive 108.

The combustion engine 101, e.g. an internal combustion engine, may be controlled by the engine's control system via a control device 115. Likewise, the clutch 106 and the gearbox 103 may be controlled by the vehicle's control system, with the help of one or more applicable control devices (not shown). Naturally, the vehicle's powertrain may also be of another type, such as a type with a conventional automatic gearbox, or a type with a hybrid driveline, etc.

The vehicle 100 also comprises an exhaust treatment/purification system 250, 350 for treatment/purification of exhaust emissions resulting from combustion in the combustion chamber of the combustion engine 101.

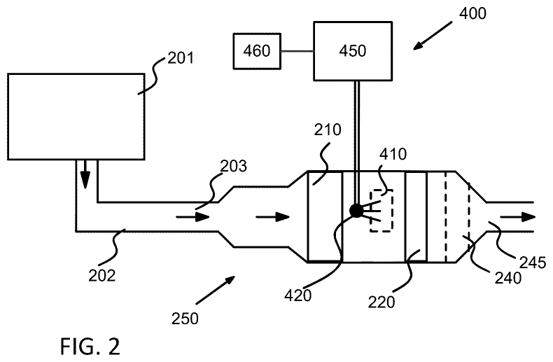

FIG. 2 shows an exhaust treatment system 250, which may illustrate a so-called Euro VI-system. The exhaust treatment system 250 is connected to a combustion engine 201, e.g. an internal combustion engine, e.g. via an exhaust conduit 202, wherein the exhausts generated at the combustion, that is to say the exhaust stream 203, is indicated with arrows. The exhaust stream 203 is led to a coated diesel particulate filter (cDPF) 210, which is coated with a catalytically oxidising coating, for example comprising at least one precious metal. Alternatively, a diesel oxidation catalyst (DOC) followed downstream by an uncoated diesel particulate filter (DPF) or a coated diesel particulate filter (cDPF) may be arranged in the exhaust treatment system 250 instead of the coated diesel particulate filter. Thus, either of a coated diesel particulate filter, and a diesel oxidation catalyst followed by a diesel particulate filter (DPF/cDPF) is arranged downstream of the combustion engine 201 in the exhaust treatment system 250.

During the combustion in the combustion engine 201, soot and ash are created, and the coated diesel particulate filter 210, or alternatively the diesel particulate filter, is used to catch the soot and ash. The exhaust stream 203 is here led through a filter structure, wherein soot and ash from the exhaust stream 203 are caught when passing through, and are stored in the particulate filter 210.

The catalytic coating in the coated diesel particulate filter 210, or alternatively in the oxidation catalyst, has several functions and is normally used primarily to oxidize, during the exhaust treatment, remaining hydrocarbons CₓH_{y} (also referred to as HC) and carbon monoxide CO in the exhaust stream 203 into carbon dioxide CO₂ and water H₂O. Also, a large fraction of the nitrogen monoxides NO occurring in the exhaust stream may be oxidized into nitrogen dioxide NO₂. The oxidation of nitrogen monoxide NO into nitrogen dioxide NO₂ is important to the nitrogen dioxide-based soot and ash oxidation in the filter, and is also advantageous at a potential subsequent reduction of nitrogen oxides NOₓ.

In this respect, the exhaust treatment system 250 further comprises a selective catalytic reduction (SCR) catalyst 220 arranged downstream of the diesel particulate filter 210. The selective catalytic reduction catalyst 220 uses ammonia NH₃, or a composition from which ammonia may be generated/formed, e.g. urea, as a reductant/additive for the reduction of nitrogen oxides NOₓ in the exhaust stream 203. After passing through the components of the exhaust treatment system, the exhaust stream is emitted into the environment at the tailpipe 245.

The reaction rate of this reduction is impacted, however, by the ratio between nitrogen monoxide NO and nitrogen dioxide NO₂ in the exhaust stream, so that the reductive reaction is impacted in a positive direction by the previous oxidation of NO into NO2 in the coated diesel particulate filter, or alternatively in the oxidation catalyst DOC.

The selective catalytic reduction catalyst 220 requires a reductant/additive to reduce the concentration of a compound, such as for example nitrogen oxides NOₓ, in the exhaust stream 203. Such reductant is injected into the exhaust stream downstream of the particulate filter 210 and upstream of the selective catalytic reduction catalyst 220, by a reductant doser 420 of a reductant delivery system 400 shown in FIG. 2. The reductant doser 420 may also be denoted reductant/additive dosing/injection arrangement/device. The reductant/additive is often ammonia and/or urea based, or consists of a substance from which ammonia may be extracted or released, and may for example consist of AdBlue, which basically consists of urea mixed with water. Urea forms ammonia at heating (thermolysis) and at heterogeneous catalysis on an oxidizing surface (hydrolysis), which surface may, for example, consist of titanium dioxide TiO₂, within the selective catalytic reduction catalyst 220. The exhaust treatment system may also comprise a separate hydrolysis catalyst. The reductant may be provided from a container/tank 450 of the reductant delivery system 400, and the dosing of the reductant may be controlled by a control unit/system 460. The reductant delivery system 400 is explained more in detail below.

An evaporator 410, which may comprise substantially any suitable hydrolysis coating, and/or a mixer, is arranged at the reductant doser 420. The hydrolysis catalyst, and/or the mixer, are then used to increase the speed of the decomposition of urea into ammonia, and/or to mix the additive with the emissions, and/or to vaporize the additive.

The exhaust treatment system 250 may further be equipped with a slip-catalyst (SC) 240, which is arranged downstream of the selective catalytic reduction catalyst 220 to oxidize an excess of ammonia that may remain in the exhausts after the selective catalytic reduction catalyst 220, an/or to assist the selective catalytic reduction catalyst 220 with further reduction of NOₓ. Accordingly, the slip-catalyst 240 may provide a potential for improving the system's total conversion/reduction of NOₓ.

The exhaust treatment system 250 may also be equipped with one or several sensors, such as one or several NOₓ and/or temperature sensors for the determination of nitrogen oxides and/or temperatures in the exhaust treatment system.

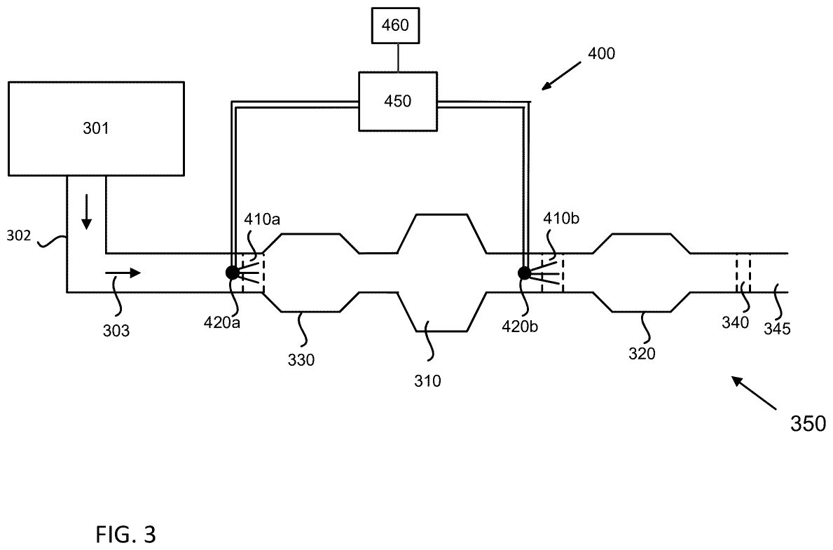

FIG. 3 schematically shows another exhaust treatment system 350, which is connected via an exhaust pipe 302 to a combustion engine 301, e.g. an internal combustion engine. Exhausts are generated at combustion in the engine 301 and the exhaust stream 303 (indicated with arrows) are led to an upstream reductant doser 420a of a reductant delivery system 400, arranged to add/inject a reductant/additive into the exhaust stream 303. An upstream selective catalytic reduction (SCR) catalyst 330 is arranged downstream of the upstream reductant doser 420a. The upstream selective catalytic reduction catalyst 330 is arranged to reduce nitrogen oxides NOₓ in the exhaust stream 303, through the use of the reductant added to the exhaust stream by the upstream reductant doser 420a. In more detail, the upstream selective catalytic reduction catalyst 330 uses the reductant, for example ammonia NH₃, or a substance from which ammonia may be generated/formed/released, for the reduction of nitrogen oxides NOₓ in the exhaust stream 303. This additive may for example consist of the above mentioned AdBlue, and may be provided from a container/tank 450 of the reductant delivery system 400. The injection of the reductant may be controlled by a control unit/system 460.

Downstream of the upstream selective catalytic reduction catalyst 330, the exhaust treatment system 350 further comprises a coated diesel particulate filter (cDPF) 310, which is coated with a catalytically oxidising coating, for example comprising at least one precious metal for catching and oxidising soot and ash. Alternatively, a diesel oxidation catalyst (DOC) followed downstream by a diesel particulate filter (DPF/CDPF) may be arranged in the exhaust treatment system 350 instead of the coated diesel particulate filter. Thus, either of a coated diesel particulate filter and a diesel oxidation catalyst followed by a diesel particulate filter (DPF/cDPF) is arranged downstream of the upstream reduction catalyst device 330 in the exhaust treatment system 350.

Downstream of the particulate filter 310, the exhaust treatment system 350 comprises a downstream reductant doser 420b of the reductant delivery system 400, which is arranged to supply reductant into the exhaust stream 303, where such a second reductant comprises ammonia NH₃, or a substance, for example AdBlue, from which ammonia may be generated/formed/released, as described above. The downstream reductant may here be the same additive as the above mentioned reductant/additive injected by the upstream reductant doser 420a, and may possibly also come from the same container/tank 450. Alternatively, the reductants injected by the upstream 420a and downstream 420b reductant dosers, respectively, may also be of different types and/or may come from different tanks. The injection performed by the downstream reductant doser 420b may be controlled by a control unit/system 460.

An evaporator 410a, 410b may be arranged at the upstream 420a and/or downstream 420b reductant dosers, respectively, to increase the speed of the decomposition of urea into ammonia, and/or to mix the additive with the emissions, and/or to vaporize the additive.

The exhaust treatment system 350 also comprises a downstream selective catalytic reduction (SCR) catalyst 320, which is arranged downstream of the downstream reductant doser 420b. The downstream selective catalytic reduction catalyst 320 is arranged to reduce nitrogen oxides NOₓ in the exhaust stream 303 through use of the reductant injected by the downstream reductant doser 420b, and possibly also reductant remaining in the exhaust stream 303 which was injected by the upstream reductant doser 420a.

The exhaust treatment system 350 may further be equipped with a slip-catalyst (SC) 340, which is arranged downstream of the downstream selective catalytic reduction catalyst 320 to oxidize an excess of ammonia that may remain in the exhausts after the downstream selective catalytic reduction catalyst 320, an/or to assist the selective catalytic reduction catalyst 320 with further reduction of NOₓ. Accordingly, the slip-catalyst 340 may provide a potential for improving the system's total conversion/reduction of NOₓ.

After passing through the components of the exhaust treatment system 350, the exhaust stream is emitted into the environment at the tailpipe 345 of the exhaust treatment system 350.

The exhaust treatment system 350 may also be equipped with one or several sensors (not shown), such as one or several NOₓ sensors and/or one or several temperature sensors, which are arranged for the determination of NOₓ-concentrations and temperatures in the exhaust treatment system 350, respectively.

Through the use of the exhaust treatment system 350 shown in FIG. 3, both the upstream selective catalytic reduction catalyst 330 and the downstream selective catalytic reduction catalyst 320 may be optimized with respect to a selection of catalyst characteristics for the reduction of nitrogen oxides NOₓ, and/or with respect to volumes for the upstream 330 and downstream 320 selective catalytic reduction catalysts, respectively.

The particulate filter 310 may hereby be used to improve the efficiency, by taking into account how its thermal mass, i.e. its thermal inertia, impacts the temperature of the downstream selective catalytic reduction catalyst 320. By taking into account the thermal inertia of the particulate filter 310, the upstream selective catalytic reduction catalyst 330 and the downstream selective catalytic reduction catalyst 320, respectively, may be optimized with respect to the specific temperature function each will experience.

For both the upstream 330 and downstream 320 selective catalytic reduction catalysts, its catalytic characteristics may be selected based on the environment to which it is exposed, or will be exposed to. Additionally, the catalytic characteristics for the upstream 330 and downstream 320 selective catalytic reduction catalyst may be adapted so that they may be allowed to operate in symbiosis with each other. The upstream 330 and downstream 320 selective catalytic reduction catalysts may also comprise one or several materials, providing the catalytic characteristic. For example, transition metals such as vanadium and/or tungsten may be used, for example in a catalyst comprising V₂O₅/WO₃/TiO₂. Metals such as iron and/or copper may also be comprised in the upstream 330 and/or downstream 320 selective catalytic reduction catalysts, for example in a Zeolite-based catalyst.

The exhaust treatment system 350 reduces the amount of nitrogen oxides NOₓ in the exhaust stream in substantially all driving modes, comprising especially cold starts and throttle, that is to say increased requested torque.

The above mentioned small-sized individual solid reductant particles may be created by the supply of the reductant/additive into the exhaust stream 203, 303, and may comprise urea and/or by-products based on urea, as mentioned above. In the exhaust treatment system illustrated in FIG. 2, the individual solid reductant particles may thus be created at the reductant doser 420 and/or the evaporator 410. In the exhaust treatment system illustrated in FIG. 3, the individual solid reductant particles may thus be created at the upstream reductant doser 420a, at the downstream reductant doser 420b and/or at the corresponding evaporators 410a, 410b.

According to an aspect of the present invention, a reductant delivery system 400 configured to supply a reductant into an exhaust stream 203, 303 in an exhaust treatment system 250, 350 is presented. The exhaust stream 203, 303 is a result of a combustion in a combustion engine 201, 301 and the exhaust treatment system 250, 350 is configured for treatment of the exhaust stream 203, 303 by utilization of the reductant.

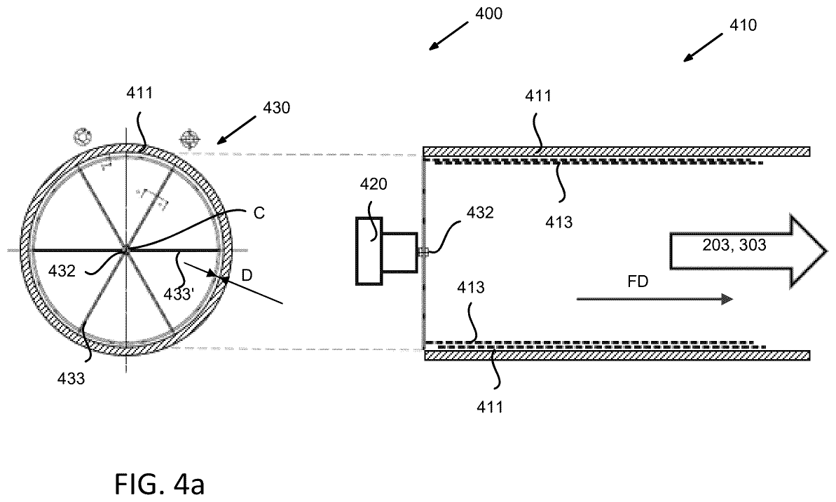

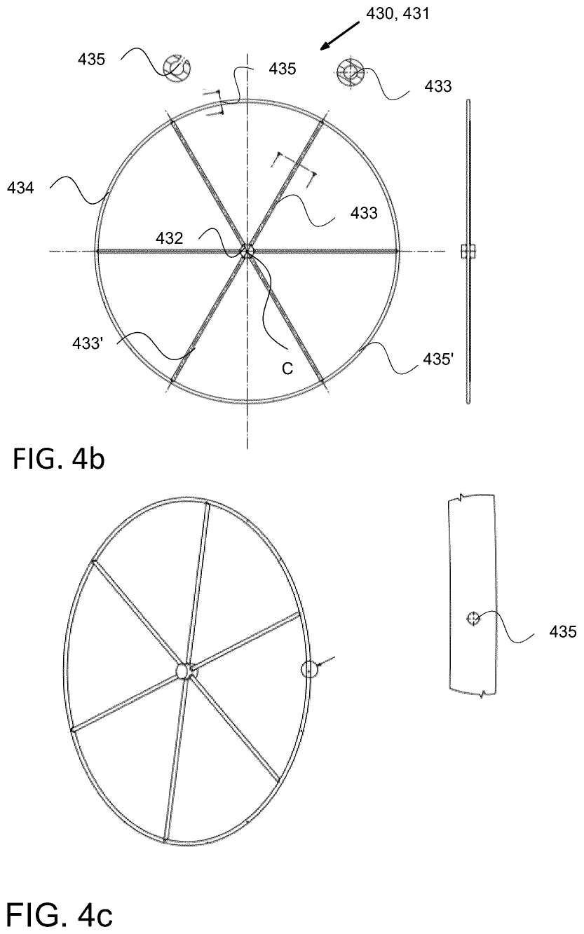

The reductant delivery system 400 comprises an evaporator 410, schematically illustrated for various embodiments in FIGS. 4a, 6a, 7a, and 8a-c. The evaporator 410 is configured to mix the reductant with the exhaust stream 203, 303 flowing through the evaporator 410.

The reductant delivery system 400 further comprises a reductant doser 420 configured essentially in a center C of a cross section of the evaporator 410 to provide the reductant in fluid form to a tube arrangement 430. The cross section of the evaporator 410 is perpendicular to a flow direction FD of the exhaust stream 203, 303, i.e. is perpendicular to a longitudinal/axial direction/extension of the evaporator 410. According to an embodiment, the evaporator 410 has an essentially circular cross section.

The reductant delivery system 400 further comprises a tube arrangement 430, which is configured between the reductant doser 420 and at least one evaporating surface 411, 411a, 411b of the evaporator 410. The tube arrangement 430 is configured to receive the reductant in fluid form from the reductant doser 420 and to deliver the reductant in fluid form at the at least one evaporating surface 411, 411a, 411b. Hereby, the reductant is distributed as a liquid wall film 413, 413a, 413b on the at least one evaporating surface 411, 411a, 411b.

According to an embodiment, the reductant delivery system 400 is configured such that the reductant is delivered in fluid form at the at least one evaporating surface 411, 411a, 411b in a way such that transformation of the reductant from the fluid form into a spray form when supplying the reductant into the exhaust stream 203, 303 is avoided. Hereby, the delivery of the reductant in fluid form at the at least one evaporating surface 411, 411a, 411b is performed such that creation of individual solid particles having a diameter less than 23 nm by the supply of the reductant into the exhaust stream 203, 303 is prevented. Thus, by usage of the presented reductant delivery system 400, the number of individual solid particles having a diameter less than 23 nm and being emitted into the environment at the tailpipe is considerably reduced.

According to an embodiment, the tube arrangement 430 of the reductant delivery system 400 is configured to deliver the reductant at a distance D from the at least one evaporating surface 411, 411a, 411b, where the distance D is in an interval of 0-10 mm. Thus, the reductant is delivered/applied directly onto, or immediately adjacent to, the at least one evaporating surface 411, 411a, 411b such that it is kept in liquid form and is distributed as a liquid wall film 413, 413a, 413b on the at least one evaporating surface 411, 411a, 411b.

According to an embodiment schematically shown in FIGS. 4a-c and 5a-b, the tube arrangement 430 is configured in form of a wheel 431, i.e. is essentially wheel-formed. The tube arrangement 430 then comprises a hub 432 of the wheel, wherein the hub 432 is configured to receive the reductant in fluid form from the reductant doser 420. The tube arrangement 430 further comprises two or more spoke tubes 433, 433′ configured from the hub 432 to a rim tube 434 of the wheel to provide the reductant in fluid form from the hub 432 to the rim tube 434 within the spoke tubes. The rim tube 434 is here arranged circumferentially at the proximal ends of the two or more spoke tubes 433, 433′,

The rim tube 434 comprises two or more circumferential openings 435, 435′ directed towards the at least one evaporating surface 411, 411a. The two or more circumferential openings 435, 435′ are configured to provide the reductant in fluid form at the at least one evaporating surface 411, 411a.

Thus, as schematically illustrated in FIGS. 4a-b and 5a, the reductant flows in liquid form from the reductant doser 420, to the hub 432 of the tube arrangement 430, through the two or more spoke tubes 433, 433′ and to the rim tube 434 of the tube arrangement 430. The fluid reductant is then provided in fluid form onto the at least one evaporating surface 411, 411a via the two or more circumferential openings 435, 435′ of the rim tube 434, being directed towards the at least one evaporating surface 411, 411a.

According to an embodiment schematically illustrated in FIGS. 4b-c, at least one 435 of the two or more circumferential openings 435, 435′ is shaped as a circular hole. Thus, the reductant is here provided onto the at least one evaporating surface 411, 411a through the at least one circular hole 435 of the rim tube 434.

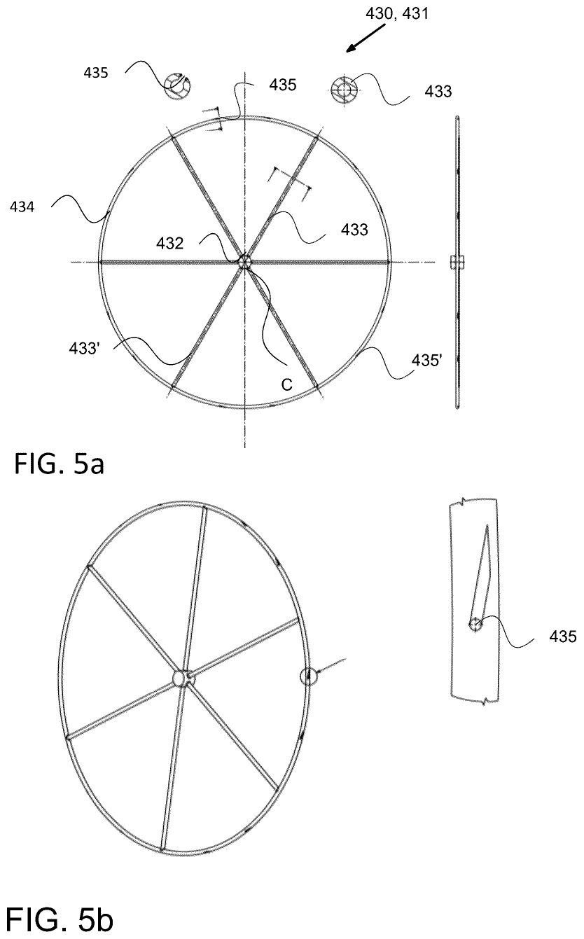

According to an embodiment schematically illustrated in FIGS. 5a-b, at least one 435 of the two or more circumferential openings 435, 435′ is shaped as a guide slot.

The guide slot has a form/design configured to provide the reductant in fluid form onto the at least one evaporating surface 411, 411a as a swirl. Thus, the form of the guide slot causes a swirl of the reductant when it leaves the rim tube 434 and is provided onto the at least one evaporating surface 411, 411a.

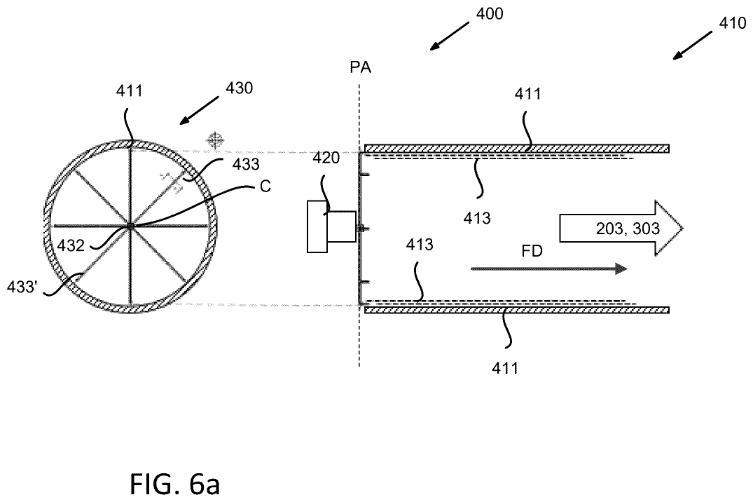

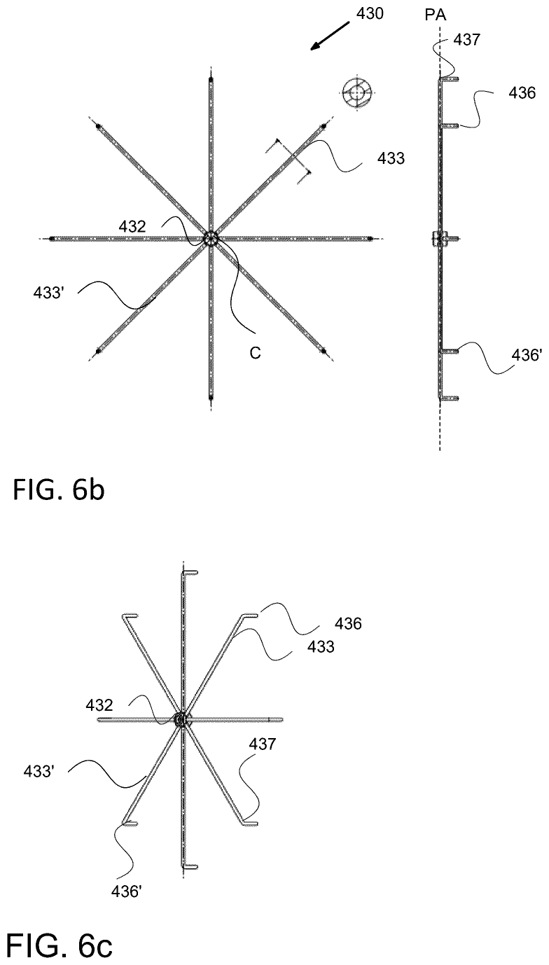

According to some embodiments schematically illustrated in FIGS. 6a-c, 7a-d and 8a-e, the tube arrangement 430 comprises a hub 432 configured to receive the reductant in fluid form from the reductant doser 420. The tube arrangement 430 further comprises two or more spoke tubes 433, 433′ configured directed radially out from the hub 432 towards the at least one evaporating surface 411, 411a, 411b. In these embodiments, there is no circumferential rim tube arranged at the end of the spoke tubes 433, 433′. Each spoke tube 433, 433′ comprises at least one delivery port 436, 436′, 436a, 436a′, 436b, 436b′ configured adjacent to the at least one evaporating surface 411, 411a, 411b, respectively. The fluid reductant is transported within the spoke tubes 433, 433′ from the hub 432 to the at least one delivery port 436, 436′, 436a, 436a′. The at least one delivery port 436, 436′, 436a, 436a′, 436b, 436b′ is configured to deliver the reductant in fluid form at the at least one evaporating surface 411, 411a, 411b, respectively.

According to an embodiment schematically illustrated in FIGS. 6a-c, the two or more spoke tubes 433, 433′ are configured in one axial plane PA perpendicular to the flow direction FD of the exhaust stream 203, 303, i.e. are perpendicular to a longitudinal/axial direction/extension of the evaporator 410. Thus, the two or more spoke tubes 433, 433′ are configured as spokes of a wheel.

According to an embodiment schematically illustrated in FIGS. 6a-c and 8a-e, at least one of the two or more delivery ports 436, 436′, 436a, 436a′, 436b, 436b′ is formed as a bend/angle/hook/arch 437 adjacent to an evaporation surface 411, 411a, 411b, thereby delivering the reductant onto the at least one evaporating surface 411, 411a, 411b as a liquid wall film 413, 413a, 413b.

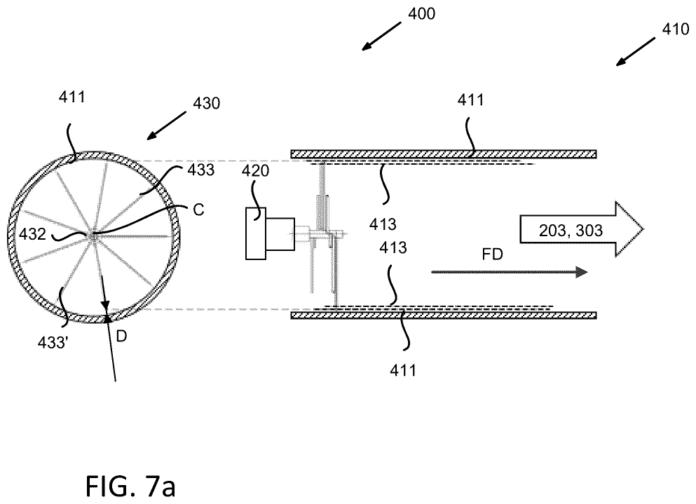

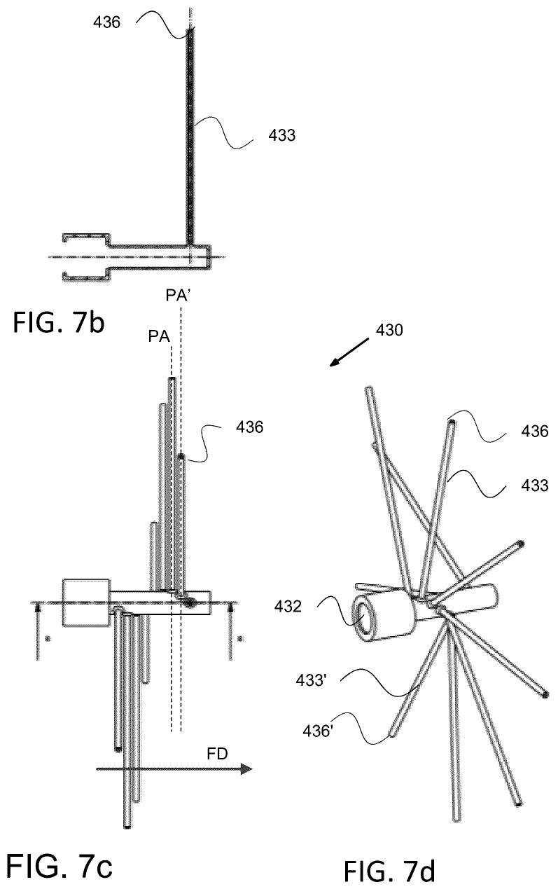

According to an embodiment schematically illustrated in FIGS. 7a-d the two or more spoke tubes 433, 433′ are arranged in a spiral configuration on the hub 432. Each spoke tube 433, 433′ is here arranged in a separate axial plane PA, PA′ perpendicular to the flow direction FD of the exhaust stream 203, 303, i.e. perpendicular to a longitudinal/axial direction/extension of the evaporator 410.

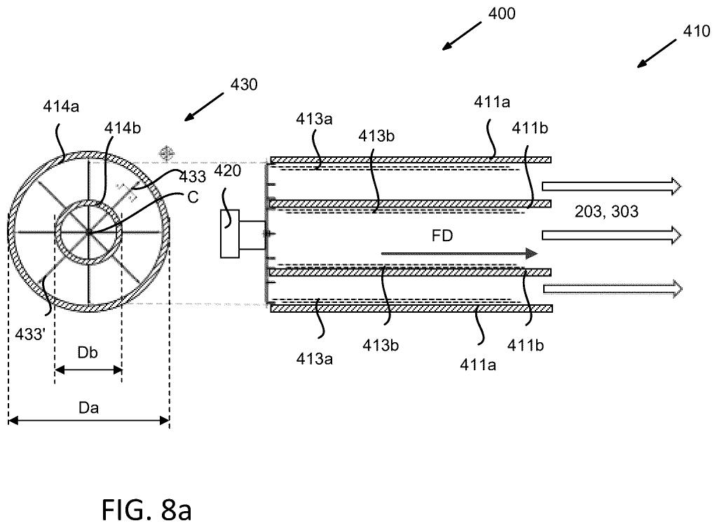

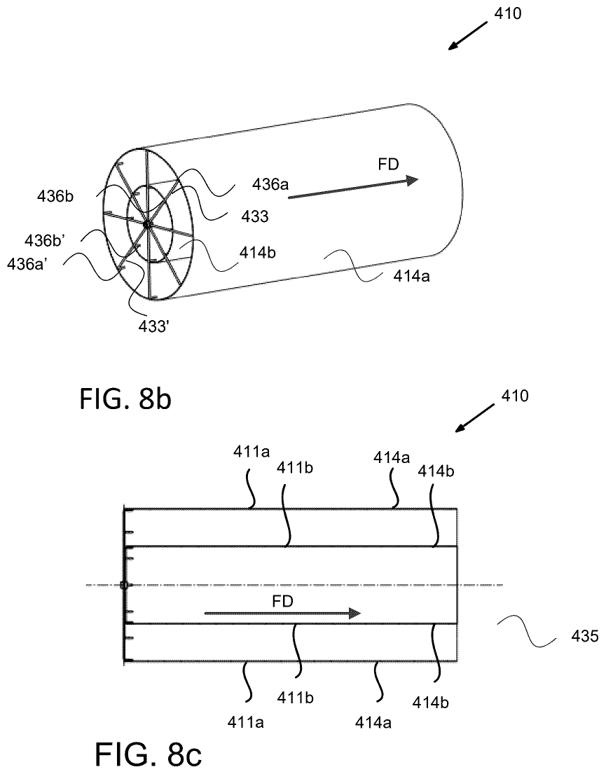

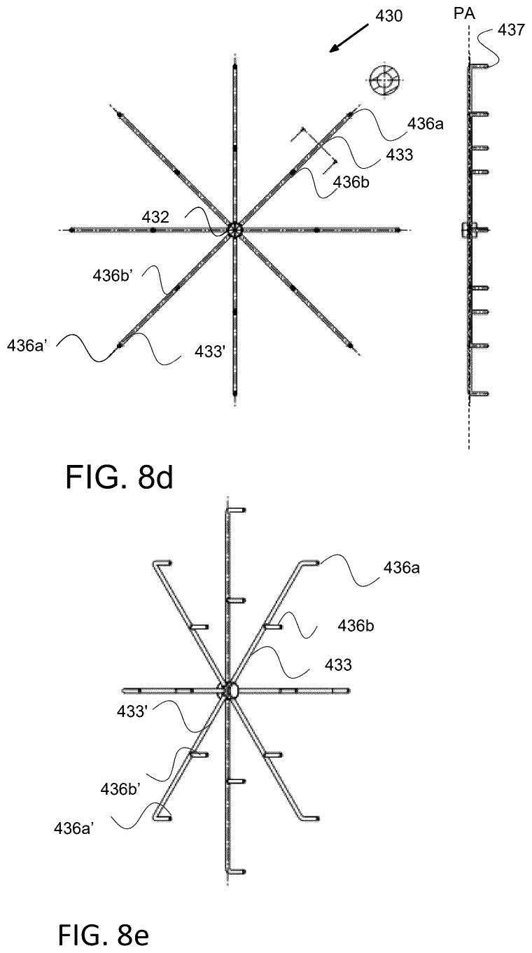

According to an embodiment schematically illustrated in FIGS. 8a-e, the evaporator 410 comprises two or more concentric evaporation pipes 414a, 414b, having differing diameters Da, Db, through which the exhaust stream 203, 303 flows. These two or more concentric evaporation pipes 414a, 414b form two or more evaporation surfaces 411a, 411b, respectively, as schematically illustrated in FIGS. 8a and 8c.

Each spoke tube 433, 433′ of the tube arrangement 430 comprises two or more delivery ports 436a, 436a′, 436b, 436b′, as illustrated in FIGS. 8b and 8d-e. At least one of these delivery ports 436a, 436a′, 436b, 436b′ of the spoke tube 433, 433′ is configured at each of the two or more evaporation surfaces 411a, 411b of the evaporator 410.

For example, as illustrated in FIGS. 8b-e, a first spoke tube 433 comprises a first delivery port 436a at a first outer evaporation surface 411a of a first outer evaporation pipe 414a, and a second delivery port 436b at a second inner evaporation surface 411b of a second inner evaporation pipe 414b. Correspondingly, a second spoke tube 433′ comprises a first delivery port 436a′ at a first outer evaporation surface 411a of a first outer evaporation pipe 414a, and a second delivery port 436b′ at a second inner evaporation surface 411b of a second inner evaporation pipe 414b. The tube arrangement 430 may comprise essentially any suitable number of spoke tubes. Each one of the spoke tubes of the tube arrangement 430 may comprise such a first inner delivery port and a second outer delivery port.

FIGS. 8d-e schematically illustrate example tube arrangements 430 for the evaporators 410 comprising two or more concentric evaporation pipes 414a, 414b. A first spoke tube 433 comprises a first outer delivery port 436a and a second inner delivery port 436b. Correspondingly, a second spoke tube 433′ comprises a first outer delivery port 436a′ and a second inner delivery port 436b′. As mentioned above, the tube arrangement 430 may comprise essentially any suitable number of spoke tubes, and each one of these spoke tubes may comprise such a first inner delivery port and a second outer delivery port.

Although FIGS. 8a-e schematically illustrate a tube arrangement 430 having delivery ports 436a, 436a′, 436b, 436b′ formed as a bends to be configured adjacent to evaporation surfaces 411a, 411b, essentially any herein described suitable tube arrangement may be configured such that it delivers reductant at two or more evaporation surfaces 411a, 411b.

According to an embodiment, the herein described reductant delivery system 400 is utilized in an exhaust treatment system 250 as illustrated in FIG. 2, i.e. in an exhaust treatment system 250 arranged for treatment of an exhaust stream 203 resulting from a combustion in a combustion engine 201. The exhaust treatment system 250 comprises a particulate filter 210 arranged to catch soot and ash created by the combustion. The exhaust treatment system 250 further comprises the herein described reductant delivery system 400 arranged downstream of the particulate filter 210, where the reductant delivery system 400 is configured to mix the reductant with the exhaust stream 203. The exhaust treatment system 250 further comprises a selective catalytic reduction catalyst 220 arranged downstream of the reductant delivery system 400 for reduction of nitrogen oxides NOₓ in the exhaust stream 203 by utilization of the supplied reductant.

According to an embodiment, the herein described reductant delivery system 400 is utilized in an exhaust treatment system 350 as illustrated in FIG. 3, i.e. in an exhaust treatment system 350 arranged for treatment of an exhaust stream 303 resulting from a combustion in a combustion engine 301. The exhaust treatment system 350 comprises an upstream dosing device 420a arranged to supply a reductant into the exhaust stream 303. The exhaust treatment system 250 further comprises an upstream selective catalytic reduction catalyst 330 arranged downstream of the upstream dosing device 420a for reduction of nitrogen oxides NOₓ in the exhaust stream 303 by utilizing the supplied reductant. The exhaust treatment system 250 further comprises a particulate filter 310 arranged downstream of the upstream selective catalytic reduction catalyst 330 to catch soot and ash created by the combustion. The exhaust treatment system 250 further comprises the herein described reductant delivery system 400, comprising a downstream reductant dosing device 420b and a downstream evaporator 410b, arranged downstream of the particulate filter 310, where the reductant delivery system 400 is configured to mix the reductant with the exhaust stream 303. The exhaust treatment system 250 further comprises a downstream selective catalytic reduction catalyst 320 arranged downstream of the reductant delivery system 400 to reduce nitrogen oxides NOₓ in the exhaust stream 303 by utilizing the supplied reductant.

According to an embodiment, the herein described reductant delivery system 400, comprising an upstream reductant dosing device 420a and un upstream evaporator 410a is utilized for supplying the reductant into the exhaust stream 303 also upstream of the upstream selective catalytic reduction catalyst 330. Thus, the herein described reductant delivery system 400 then injects reductant both upstream of the upstream selective catalytic reduction catalyst 330 and upstream of the downstream selective catalytic reduction catalyst 320.

The present invention is not limited to the embodiments of the invention described above, but relates to and comprises all embodiments within the scope of the enclosed independent claims.

1. A reductant delivery system configured to supply a reductant into an exhaust stream in an exhaust treatment system, the exhaust stream being a result of a combustion in a combustion engine and the exhaust treatment system being configured for treatment of the exhaust stream by utilization of the reductant, wherein the reductant delivery system comprises:
an evaporator configured to mix the reductant with the exhaust stream flowing through the evaporator;
a reductant doser configured essentially in a center of a cross section of the evaporator to provide the reductant in fluid form to a tube arrangement, the cross section being perpendicular to a flow direction of the exhaust stream; and
the tube arrangement configured between the reductant doser and at least one evaporating surface of the evaporator; to receive the reductant in fluid form from the reductant doser and to deliver the reductant in fluid form at the at least one evaporating surface, such that the reductant is distributed as a liquid wall film on the at least one evaporating surface.

2. The reductant delivery system as claimed in claim 1, wherein the tube arrangement is configured in form of a wheel comprising:
a hub configured to receive the reductant in fluid form from the reductant doser;
two or more spoke tubes configured from the hub to a rim tube to provide the reductant in fluid form from the hub to the rim tube; and
the rim tube comprising two or more circumferential openings directed towards the at least one evaporating surface, the two or more circumferential openings being configured to provide the reductant in fluid form at the at least one evaporating surface.

3. The reductant delivery system as claimed in claim 2, wherein at least one of the two or more circumferential openings is shaped as a circular hole.

4. The reductant delivery system as claimed in claim 2, wherein
at least one of the two or more circumferential openings is shaped as a guide slot; and
the guide slot is configured to provide the reductant in fluid form onto the at least one evaporating surface as a swirl.

5. The reductant delivery system as claimed in claim 1, wherein the tube arrangement comprises:
a hub configured to receive the reductant in fluid form from the reductant doser; and
two or more spoke tubes configured radially from the hub towards the at least one evaporating surface, where each spoke tube comprises at least one delivery port configured adjacent to the at least one evaporating surface, respectively, the at least one delivery port being configured to deliver the reductant in fluid form at the at least one evaporating surface respectively.

6. The reductant delivery system as claimed in claim 5, wherein the two or more spoke tubes are configured in one axial plane perpendicular to the flow direction of the exhaust stream.

7. The reductant delivery system as claimed in claim 6, wherein
the evaporator comprises two or more concentric evaporation pipes through which the exhaust stream flows, the two or more concentric evaporation pipes forming two or more evaporation surfaces, respectively; and
each spoke tube comprises two or more delivery ports, of which at least one delivery port is configured at each of the two or more evaporation surfaces.

8. The reductant delivery system as claimed in claim 6, wherein at least one of the two or more delivery ports is formed as a bend adjacent to an evaporation surface.

9. The reductant delivery system as claimed in claim 5, wherein the two or more spoke tubes are arranged in a spiral configuration on the hub, such that each spoke tube is arranged in a separate axial plane perpendicular to the flow direction of the exhaust stream.

10. The reductant delivery system as claimed in claim 1, wherein the delivery of the reductant in fluid form at the at least one evaporating surface is configured to avoid transforming the reductant from the fluid form into a spray form when supplying the reductant into the exhaust stream.

11. The reductant delivery system as claimed in claim 1, wherein the delivery of the reductant in fluid form at the at least one evaporating surface is configured to prevent individual solid particles having a diameter less than 23 nm from being created by the supply of the reductant into the exhaust stream.

12. The reductant delivery system as claimed in claim 11, wherein the individual solid particles comprise one or more in the group of:
urea; and
by-products based on urea.

13. The reductant delivery system as claimed in claim 1, wherein the reductant comprises one or more in the group of:
ammonia; and
a substance from which ammonia may be extracted and/or released.

14. The reductant delivery system as claimed in claim 1, wherein the tube arrangement is configured to deliver the reductant at a distance D in an interval of 0-10 mm from the at least one evaporating surface.

15. An exhaust treatment system arranged for treatment of an exhaust stream resulting from a combustion in a combustion engine, the exhaust treatment system comprising:
a particulate filter arranged to catch soot and ash created by the combustion;
a reductant delivery system arranged downstream of the particulate filter, the reductant delivery system configured to supply a reductant into the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in fluid form to a tube arrangement, the cross section being perpendicular to a flow direction of the exhaust stream; and
the tube arrangement configured between the reductant doser and at least one evaporating surface of the evaporator to receive the reductant in fluid form from the reductant doser and to deliver the reductant in fluid form at the at least one evaporating surface, such that the reductant is distributed as a liquid wall film on the at least one evaporating surface; and
a selective catalytic reduction catalyst arranged downstream of the reductant delivery system for reduction of nitrogen oxides NOₓ in the exhaust stream by utilization of the supplied reductant.

16. An exhaust treatment system arranged for treatment of an exhaust stream resulting from a combustion in a combustion engine, the exhaust treatment system comprising:
an upstream dosing device arranged to supply a reductant into the exhaust stream;
an upstream selective catalytic reduction catalyst arranged downstream of the upstream dosing device for reduction of nitrogen oxides NOₓ in the exhaust stream by utilizing the supplied reductant;
a particulate filter arranged downstream of the upstream selective catalytic reduction catalyst to catch soot and ash created by the combustion;
a reductant delivery system arranged downstream of the particulate filter, the reductant delivery system configured to supply a reductant into the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in fluid form to a tube arrangement, the cross section being perpendicular to a flow direction of the exhaust stream; and
the tube arrangement configured between the reductant doser and at least one evaporating surface of the evaporator to receive the reductant in fluid form from the reductant doser and to deliver the reductant in fluid form at the at least one evaporating surface, such that the reductant is distributed as a liquid wall film on the at least one evaporating surface; and
a downstream selective catalytic reduction catalyst arranged downstream of the reductant delivery system to reduce nitrogen oxides NOₓ in the exhaust stream by utilizing the supplied reductant.

17. A vehicle comprising an exhaust treatment system arranged for treatment of an exhaust stream resulting from a combustion in a combustion engine of the vehicle, the exhaust treatment system comprising:
a particulate filter arranged to catch soot and ash created by the combustion;
a reductant delivery system arranged downstream of the particulate filter, the reductant delivery system configured to supply a reductant into the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in fluid form to a tube arrangement, the cross section being perpendicular to a flow direction of the exhaust stream; and
the tube arrangement configured between the reductant doser and at least one evaporating surface of the evaporator to receive the reductant in fluid form from the reductant doser and to deliver the reductant in fluid form at the at least one evaporating surface, such that the reductant is distributed as a liquid wall film on the at least one evaporating surface; and
a selective catalytic reduction catalyst arranged downstream of the reductant delivery system for reduction of nitrogen oxides NOₓ in the exhaust stream by utilization of the supplied reductant.
